(19) United States
(12) Patent Application Publication
(10) Pub. No.: US 2021/0209554 A1
(43) Pub. Date: Jul. 8, 2021

(54) PROJECT GOVERNANCE

(71) Applicants: Bryan Alan Hill, Edison, NJ (US); John Stephen McCarty, Lyndonville, VT (US)

(72) Inventors: Bryan Alan Hill, Edison, NJ (US); John Stephen McCarty, Lyndonville, VT (US)

(21) Appl. No.: 17/207,409

(22) Filed: Mar. 19, 2021

Related U.S. Application Data
(63) Continuation of application No. 14/581,336, filed on Dec. 23, 2014.

(51) Int. Cl. G06Q 10/10; G06Q 20/06; G06Q 20/10

(52) U.S. Cl. CPC G06Q 10/101; G06Q 20/10; G06Q 20/065

(57) ABSTRACT

A computer-implemented method and system for connecting authenticated persons, willing to pay for crowd-sourced answers to technical problems, to authenticated subject matter experts willing to sell answers to these problems in return for a variety of items of value; the system comprising a secure repository for questions posed by users and answers from other users, an innovation engine for selecting subject matter experts and facilitating collaborative solutions, a project governance engine configured to optimize the development path, a pricing engine to determine the market value of the answers, a marketplace engine for exchanging items and services of value, and means for users to communicate with other users or groups of users.

### CROSS-REFERENCE TO RELATED APPLICATIONS

This application is a continuation and claims priority to U.S. patent application Ser. No. 14/581,336, filed on Dec. 23, 2014, the entire contents of which are incorporated here by reference, which is a continuation-in-part of and claims priority to U.S. patent application Ser. No. 14/121,349, filed on Aug. 23, 2014 the entire contents of which are incorporated here by reference.

### STATEMENT REGARDING FEDERALLY SPONSORED RESEARCH OR DEVELOPMENT

Not Applicable.

### TECHNICAL FIELD

The present invention relates generally to the fields of Internet-based computer-implemented methods and computer-implemented systems for projects involving community collaboration and innovation. For the purposes of this patent application, a community collaboration software is any form of collaboration software including without limitation bulletin boards, forum software, wikis, biogs, chat rooms, white boards, e-learning software, desktop sharing, file sharing, social media software, and social networking software. This invention further relates to the determination of the appropriate development path for a project among competing approaches.

### BACKGROUND

Collaboration and social networking have been active fields of development in recent years. The current state of the art in collaborative Internet-based software for innovation provides collaboration software for groups of individuals to create and share

[symbol] to achieve an individual or a group objective. Generally these systems store the collaboration for future reference and further discussion or collaboration. These existing systems have a number of limitations: first, there are substantial barriers to entry as there is no efficient way for problems to be posted to a crowd via the Internet and for all contributors to be rewarded according to the merit of the ideas that members of this crowd contribute; secondly, there is no technique or process for providing expert based communities with alternate interfaces and controls for those posing questions and those proposing answers to questions in order to serve all audiences in one framework. There has long been a need to retain individuals in collaborative application development to contribute their expertise as the value of a network is largely based on its size and level of activity. Accordingly, there has been a long felt need for solutions that address at least one or more of the aforementioned limitations. More specifically, there is a critical need for a project governance mechanism to determine the most effective approach to achieve innovation success.

### SUMMARY OF THE INVENTION

In general, in an aspect, a computer-based social network for connecting persons willing to pay for crowd-sourced answers to technical problems with subject matter experts willing to sell answers to said problems in return for any type of currency, including crypto currency or equity interests, the network system comprising: a computer network that connects a network provider with user devices for communicating over the computer network. The system is configured so a user can input initial projects, pose research problems or questions, input instructions, and receive solutions for enterprise development. The governance of the development uses an agile process with cross-functional, self-organizedteams involving adaptive planning, rapid iteration, and continual testing of features and solutions.

In general, in an aspect, a system comprising one or more processors or virtual machines, one or more memory units, one or more input devices and one or more output devices, a network, and shared memory supporting communication among the processors, for connecting persons willing to pay for crowd-sourced answers to technical problems with subject matter experts willing to sell answers to said problems in return for crypto currency or equity interests. The system comprising a computer network that connects a network provider with user devices for communicating over the computer network in which an entrepreneur or corporate representative can input initial projects, pose research problems or questions, input instructions, and receive solutions to enterprise development. The system further comprises an innovation engine that facilitates crowd-sourcing development of projects. The system further comprises a governance engine configured to direct the innovation project along the most efficient and effective path among competing alternate paths. The system further comprises a pricing engine for evaluating the compensation of subject matter experts for a solution. The system further comprises an exchange engine for facilitating trading in a marketplace of services, equity shares, currencies and other items of value.

In general, in an aspect, a machine-based method for connecting persons willing to pay for crowd-sourced answers to technical problems with subject matter experts willing to sell answers to said problems in return for any type of currency, including crypto currency or equity interests. The machine-based method comprises providing one or more secure repository (repositories) for questions to be posed by users and answered by other users, determining the market value of the ideas submitted via a pricing engine, and communicating between individual users and either other individual users or groups of users. The machine-based method comprises storing documents, media communications, and services for delivery to subject matter experts. The machine-based method in some embodiments enables users to give orders to storage modules regarding documents, media communications, and services for delivery to investors or to company purchasers.

Implementations of the machine-based method facilitates crowd-source development of projects. The machine-based method evaluates the compensation, which is due to users for idea submissions, via supply and demand or via actuarial methods, into the appropriate quantity of crypto currency, CHIPS. The machine-based method enables a user to input initial projects, to pose research problems or questions, to input instructions, and to receive solutions. The machine-based method enables users to give orders to storage modules regarding documents, media communications, and services for delivery to subject matter experts. The machine-based method enables users to give orders to storage modules regarding documents, media communications, and services for delivery to investors or to company purchasers. The machine-based method for provides using a secure, authenticated platform for facilitation of crowd-sourcing development of projects.

In general, in one aspect, a machine-based method for investing the crypto currency earned by users of the system mentioned above, in securities comprising corporate debt, convertible notes, stock indexes, futures, FOREX, stock options, stocks, and other real or virtual assets available via any market.

In general, in another aspect, a non-transitory computer readable medium for collaboratively developing enterprises, comprising program code to interactively communicate information among entrepreneurs, subject matter experts, investors and corporate representatives. In a further aspect, program code to select subjects matter experts for solving problems, the selection criteria based on historical data using predictive analytics. In a further aspect, program code to determine the value of solutions presented by subject matter experts, the determination based on historical data using predictive analytics.

Some or all of the above needs may be addressed by certain embodiments of the invention. Certain embodiments of the invention may include systems and methods for fostering collaboration among large groups of subject matter experts on questions submitted by others in return for any type of currency, including a crypto currency that can be converted to U.S. dollars or other currency at a later time or can be invested in securities, or in return for equity in any entity that is formed to exploit the concept shared by the subject matter expert. The present invention overcomes the limitations of conventional approaches by providing in a secure online community an incentive to generate innovative answers to questions related to long felt problems. Aspects and advantages of the invention will be set forth in part in the following description, or may be obvious from the description, or may be learned through practice of the invention.

One embodiment of the present invention provides an efficient method and system for experts to package their expertise and for organizations and users to acquire and consume expertise in the context of their business or industry. The present invention uses crowd-sourcing, defined as the gathering of information from multiple, independent sources via any means over a period of time irrespective of the location of the sources of the information.

Variations and modifications can be made to these exemplary embodiments of the present disclosure. Other embodiments and aspects of the invention are described in detail herein and are considered a part of the claimed invention. Such other embodiments and aspects can be understood with reference to the following detailed description, accompanying drawings, and claims.

### BRIEF DESCRIPTION OF THE FIGURES

A full and enabling disclosure of the present invention, including the best mode thereof, directed to one of ordinary skill in the art, is set forth in the specification, which makes reference to the appended figures, which are not necessarily drawn to scale, and wherein:

FIG. 1. Schematic Diagram of the Collaborative Network

FIG. 2. Schematic Diagram of Evolutionary Development Process

FIG. 3 Computer Block Diagram of Innovation Engine

FIG. 4. Computer Block Diagram of Governance Engine

FIG. 5. Computer Block Diagram of Pricing Engine

FIG. 6. Computer Block Diagram of Exchange Engine

FIG. 7. Flowchart of Project Development Path Evolution

FIG. 8. Flowchart of Client Engaging a Subject Matter Expert for a Project

FIG. 9. Flowchart of an Investor Adding to a Portfolio

FIG. 10. Flowchart of Corporate Acquisition of a Developed Product

FIG. 11. Flowchart of Transaction at the Marketplace

### DETAILED DESCRIPTION OF THE PREFERRED EMBODIMENT

Reference now will be made in detail to embodiments of the invention, one or more examples of which are illustrated more fully in the drawings. Each example is provided by way of explanation of the invention, not limitation of the invention. This invention may, however, be embodied in many different forms and should not be construed as limited to the embodiments set forth herein; rather, these embodiments are provided so that this disclosure will be thorough and complete, and will fully convey the scope of the invention to those skilled in the art. In fact, it will be apparent to those skilled in the art that various modifications and variations can be made in the present invention without departing from the scope or spirit of the invention. For instance, features illustrated or described as part of one embodiment can be used with another embodiment and such variations come within the scope of the appended claims and their equivalents.

Like numbers refer to like elements to those skilled in the art. Like numbers refer to like elements throughout. The term “exemplary” as used throughout this document is defined to mean “example.” It will be appreciated that terms such as “left”, “right”, “top”, “bottom”, “inwardly”, “outwardly”, “front”, “inner”, “up”, and “down” and other positional descriptive terms used herein below are used merely for ease of description and refer to the orientation of the components as shown in the Figures. It should be understood that any orientation of the elements described herein is within the scope of the present invention.

As desired, embodiments of the invention may include the innovation generation and governance system with more or less of the components illustrated.

The invention is described above with reference to block and flow diagrams of systems, methods, apparatuses, and/or computer program products according to exemplary embodiments of the invention. It will be understood that one or more blocks of the block diagrams and flow diagrams, and combinations of blocks in the block diagrams and flow diagrams, respectively, can be implemented by computer-executable program instructions. Likewise, some blocks of the block diagrams and flow diagrams may not necessarily need to be performed in the order presented, or may not necessarily need to be performed at all, according to some embodiments of the invention.

These computer-executable program instructions may be loaded onto a general-purpose computer, a special-purpose computer, a processor, or other programmable data processing apparatus to produce a particular machine, such that the instructions that execute on the computer, processor, or other programmable data processing apparatus create means for implementing one or more functions specified in the flow diagram block or blocks. These computer program instructions may also be stored in a non-transitory computer-readable memory that can direct a computer or other programmable data processing apparatus to function in a particular manner, such that the instructions stored in the non-transitory computer-readable memory produce an article of manufacture including instruction means that implement one or more functions specified in the flow diagram block or blocks. As an example, embodiments of the invention may provide for a computer program product, comprising a non-transitory computer-usable medium having a computer-readable program code or program instructions embodied therein, said computer-readable program code adapted to be executed to implement one or more functions specified in the flow diagram block or blocks. The computer program instructions may also be loaded onto a computer or other programmable data processing apparatus to cause a series of operational elements or steps to be performed on the computer or other programmable apparatus to produce a computer-implemented process such that the instructions that execute on the computer or other programmable apparatus provide elements or steps for implementing the functions specified in the flow diagram block or blocks. In one embodiment, a handheld device, such as a smartphone, could be used to deliver said computer program instructions so that persons could pose questions that they want answered by the community of subject matter experts and that they are willing to compensate those who deliver useful answers to and subject matter experts could input answers via said handheld device. These computer-implemented processes could be virtualized in a cloud-based environment.

Accordingly, blocks of the block diagrams and flow diagrams support combinations of means for performing the specified functions, combinations of elements or steps for performing the specified functions and program instruction means for performing the specified functions. It will also be understood that each block of the block diagrams and flow diagrams, and combinations of blocks in the block diagrams and flow diagrams, can be implemented by special-purpose, hardware-based computer systems that perform the specified functions, elements or steps, or combinations of special purpose hardware and computer instructions.

While the invention has been described in connection with what is presently considered to be the most practical and various embodiments, it is to be understood that the invention is not to be limited to the disclosed embodiments, but on the contrary, is intended to cover various modifications and equivalent arrangements included within the scope of the appended claims. Although specific terms are employed herein, they are used in a generic and descriptive sense only and not for purposes of limitation.

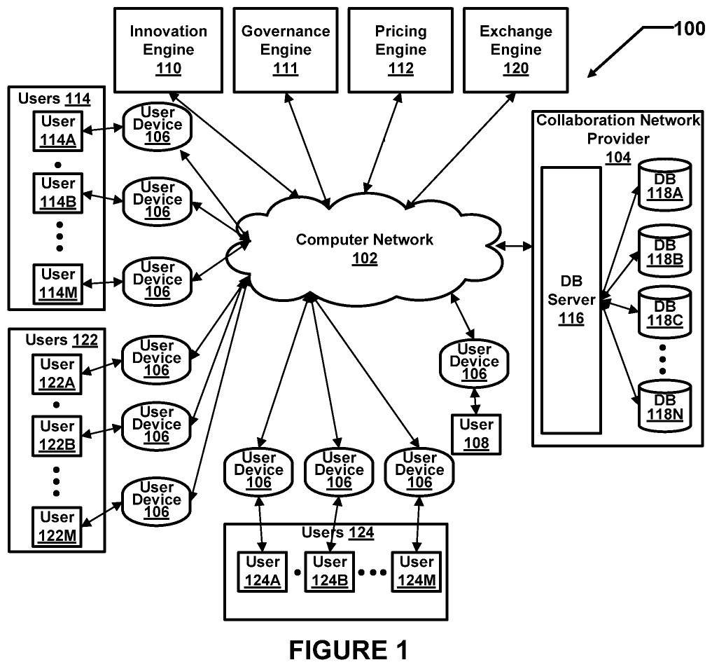

FIG. 1 illustrates an exemplary environment, 100, for collaborative development of enterprises in a computer-based social network including entrepreneurs, investors, companies, and subject matter expert contributors in a virtual incubator fueled by any currency, including a convertible crypto currency, CHIPS, which is defined as any virtual currency-like instrument that can be assessed at some given time to have value relative to other virtual currencies or non-virtual currencies, such as U.S. dollars or Euros. This convertible crypto currency could be any currently available crypto currency or any developed in the future. A computer network, 102, connects a network provider, 104, with user devices, 106, such as hand-held mobile smartphones for communicating across the computer network, 102. An entrepreneur or company user, 108, can initiate projects, pose research problems or questions, input instructions, documents, media communications, for delivery to subject matter experts, 114(114A, 1148, . . . ,114N), or investors, 122(122A, 1228, . . . , 122M), or company representatives, 124(124A, 1248, . . . , 124M). An innovation engine, 110, facilitates crowd-sourced development of projects initiated by an entrepreneur or company user, 108, with contributions from authenticated subject matter experts, 114, operating as consultant users or independent contractors. A governance engine, 111, facilitates the selection of the optimal development path for a project among competing paths. A pricing engine, 112, evaluates the contributions of subject matter experts, 114, into the appropriate quantity of crypto currency by a method of supply and demand or actuarial methods. An exchange engine, 120, for authenticated users provides a marketplace for the exchange of crypto currency for services or for the exchange of services for non-crypto currencies at current rates of exchange (FOREX, i.e., foreign exchange or the trading of currencies for other currencies) or any item of value including, but not limited to corporate debt, convertible notes, stock indexes, futures, FOREX, stock options, and other real or virtual assets available via any market.

The network provider, 104, supplies a database server, 116, to the computer network, 102, wherein the database server has one or more databases, 118 [118A, 1188, . . . , 118M], for storing projects, questions, answers, and messages as well as the profile and historical data of networked entrepreneurs, subject matter experts, company representatives, investors together with information on vendors, distributors, and the logistics needed to facilitate corporate commerce.

The system that we describe here enables members of a community or users of a network, for example, entrepreneurs, subject matter experts, investors, private and public corporations, and combinations of any two or more of those, to cause projects to be undertaken and products to be developed that launch new corporations at future times or enhance existing corporations with innovative products. Such a community provides global reach to individual and corporate entrepreneurs with problems and research needs and a global community of individual subject matter experts or corporate consultants who can solve those problems and address those needs. This form of knowledge-based crowd sourcing in a commercial context is similar to the collaborative community that has constructed site such as Wikipedia.

Implementations of the system need not be limited to networks of the kind known as social or need not all classes of users, but some implementations will be in the context of social networks or will be corporate or both. For convenience, we sometimes refer to the system in some examples as a collaborative ecosystem network, but we mean that phrase in a very broad sense to include, for example, any sort of network or grouping in which a community of users (we sometimes use the terms entrepreneur users or users who are subject matter experts (SMEs) or investor users and members interchangeably) participate, that includes members of a single project or of multiple projects, or both features. In one embodiment of the present invention, the group from which contributors would be selected could be a closed, pre-selected, group of securely authenticated members, such as a group inside of a corporation or other entity, and, in one embodiment, the compensation could be made directly in non-crypto currency or via debit cards, such as gift cards, issued in such a currency.

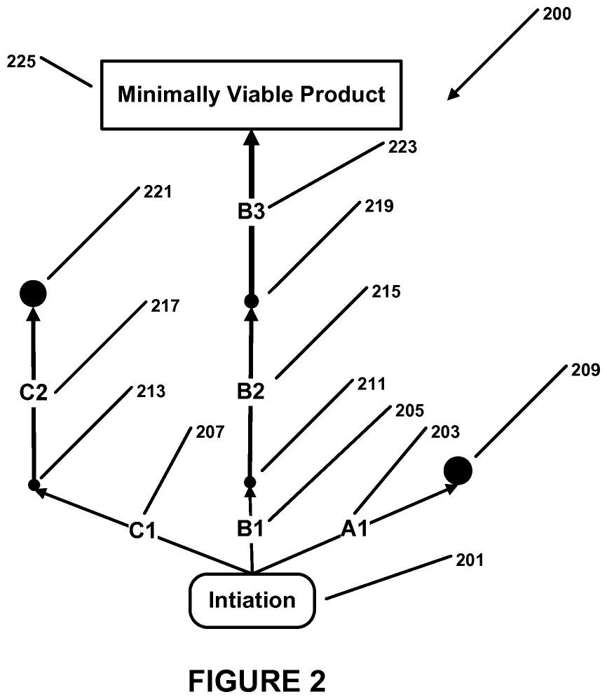

In the upcoming section reference is made to FIG. 2, a schematic diagram of the evolutionary development process, 200. Upon initiation of product development or problem solving, 201, a number of different approaches are undertaken concurrently in an agile development mode with cross-functional, self-organized teams involving adaptive planning, rapid iteration, and continual testing of features and solutions. In the first stages, A1, 81, C1, resources are equally distributed among the different approaches. When, for example, approach A in its first stage A1, 203, is tested and fails that approach is terminated, 209, and the resources redistributed. So approach 81, 205, is iterated, 211, into a second stage 82, 215, and approach C1, 207, is iterated into a second stage C2, 213. When, for example, the third approach C in its second stage C2, 217, is tested and fails that approach is terminated, 221, and the resources redistributed at the next iteration, 219, of approach 8 in the third stage, 83, 223. In this example the remaining approach, 8, achieves a solution to the problem or a minimally viable product, 225, ready for deployment to prospective users. Failure of an approach leading to termination may involve an insurmountable technical obstacle or an evaluation using predictive analytics in comparison with the other approaches that an approach has a low propensity of success relative to the other approaches or another approach has a higher return on investment.

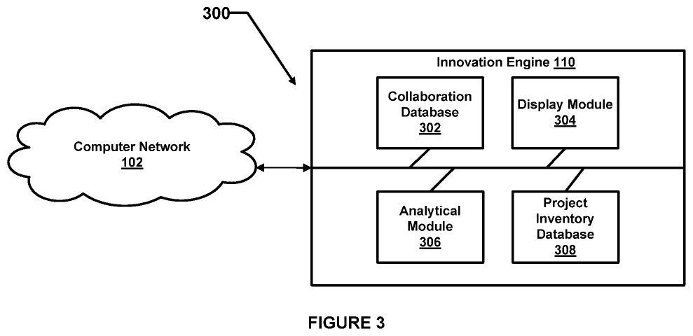

In the upcoming section reference is made to FIG. 3, a block diagram, 300, of an exemplary innovation engine, 110, which is included in the collaborative network environment, 100. The innovation engine, 110, in the network environment, 100, of FIG. 1, is configured with services for facilitating project development for an entrepreneur user, 108, by providing access to the crowd sourcing platform engaging one or more subject matter experts, 114. The project framework, including information on research problems and questions may be displayed on a webpage belonging to a subject matter user, 1148. The innovation engine, 110, is further configured for secure authentication of selected members of the collaborative who have accepted the agreement of the parties within the collaborative environment, 100. The innovation engine, 110, comprises a collaboration database, 302, a display module, 304, an analytical module, 306, together with the project inventory database of historical data, 308. Said project inventory database would include but not be limited to information on capabilities and performance of subject matter expert consultants, collaborating companies, as well as information on the net compensation of each user, the amount of crypto currency each user has, and the amount of equity each user currently owns. Using such historical data the predictive analytics of the analytical module facilitate selection of the optimal contributors to the project.

A predictive analytics submodule, 306, applies search algorithms and forecasting models stored in the project database library, 308, to select potential subject matter experts, consultants, or other resources related to the successful project. The predictive analytics submodule, 306, may implement one or more forecasting techniques, including simple algorithms, including statistical techniques such as machine learning (e.g., as applied by IBM's Watson computer), game theory, and data mining. In some examples, the predictive analytics incorporate the robust, optimizing forecasting techniques of Pinto et al. (U.S. Pat. No. 7,499,897, issued on Mar. 3, 2009; U.S. Pat. No. 7,562,058, issued on Jul. 14, 2009; U.S. Pat. No. 7,725,300, issued on May 25, 2010; U.S. Pat. No. 7,730,003, issued on Jun. 1, 2010; U.S. Pat. No. 7,933,762, issued on Apr. 26, 2011; U.S. Pat. No. 8,170,841 issued on May 1, 2012; U.S. Pat. No. 8,751,273 issued on Jun. 10, 2014 and U.S. patent application Ser. No. 10/826,949, filed Apr. 16, 2004, the contents of all of which are incorporated herein by reference), that manage historical data including historical data that may have missing values, which must be inferred.

In some examples, the predictive analytics submodule, 306, may be configured as described by Gruber et al. (U.S. patent application Ser. No. 12/987,982, filed Jan. 10, 2011, and U.S. patent application Ser. No. 13/492,809 filed Jun. 9, 2012, the contents of both of which are incorporated herein by reference). For instance, the predictive analytics submodule, 306, may include an automated assistant receiving user input. The predictive analytics submodule, 306, may also include an active ontology with representations of concepts and relations among concepts drawn from various databases of historical data. For example, in the case where the consultant is an agent of a corporation, the corporate personnel database may be referenced in the active ontology. The predictive analytics submodule, 306, may also include a language interpreter to parse the sender's input in order to derive a representation of the sender's intent in terms of the active ontology. The predictive analytics submodule, 306, may also include a services orchestration component to output responses and instructions to implement the sender's intent. A display module, 304, communicates the results of the analysis conducted by the predictive analytics submodule, 306, to the entrepreneur 108, (FIG. 1).

In another example, the predictive analytics submodule, 306, may identify potential subject matter experts based on an analysis of electronically-accessible sources of information, profile data stored in the collaboration database, 302, or both. For instance, potential collaborators may be identified that meet one or more specified characteristics (e.g., professional developers or corporate chemists). Potential collaborators may be identified by their relationship with the entrepreneur (e.g., previous members of entrepreneur's team or all social network connections of the entrepreneur). In some examples, the predictive analytics submodule, 306, may have access to resume databases to analyze characteristics of potential collaborators. In some examples, the predictive analytics submodule, 306, may have access to a list of past or potential employers and may identify and rank potential collaborators based on that list in terms of propensity to succeed based on historical data. The predictive analytics submodule developing a propensity score (MyPi) for users of the collaborative EyePi Platform may have as input information about actions, feedback and background, for example, education level and training, job experiences, user or colleague feedback, measures of prior willingness to provide feedback, quality of prior responses or feedback, input from colleagues or other peers on quality of work and feedback. Such propensity scores could be used, for example, as a differential payment modifier of remuneration by a small amount, for instance one percent.

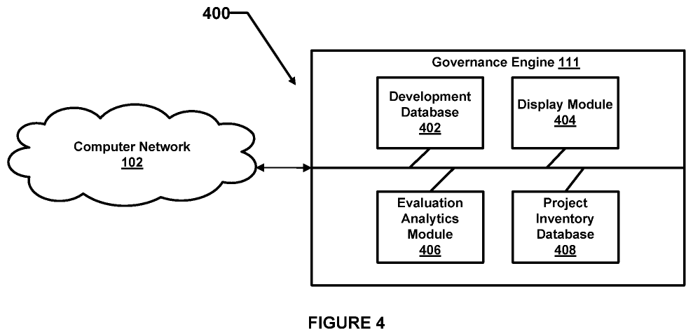

In the upcoming section reference is made to FIG. 4, a block diagram, 400, of an exemplary governance engine, 110, which is included in the collaborative network environment, 100. The governance engine, 111, in the network environment, 100, of FIG. 1, is configured with services for facilitating project development by an entrepreneur user, 108, by selecting from among one or more alternate paths the optimal path for developing a project. The project framework, including information on alternate approaches may be displayed on a webpage belonging to an entrepreneur, 108, a subject matter expert user, 1148, a corporate representative, 118C, or an investor, 124H. The governance engine, 111, is further configured for authentication and secure selection of members of the development project under the agreement of the parties within the collaborative environment, 100. The governance engine, 111, comprises a development path database, 402, a display module, 404, an analytical module, 406, and having project inventory database of historical data, 408. Said project inventory database would include but not be limited to information on capabilities and performance of subject matter expert consultants, collaborating companies, entrepreneurs, and investors. Using such historical data the evaluation analytics of the evaluation module facilitate selection of the optimal project pathway. In the collaborative development process for a project, governance is achieved, in part, by allowing each part or even the whole of a user-added contribution to a project to be evaluated in the project community. In some embodiments the evaluation would be made by the whole community or by selected members. Additionally, the value of each member's contribution may be weighted relative to others in the community. As an example, this weighting may be a fractional value between O to 1 (inclusive) where a number near or at 0 would provide minimal or no (respectively) influence and a weighting nearer or at 1 would allow increasing or total (respectively) control of governance. Governance is further comprised of a decision process of establishing consensus of evaluation that governs acceptance or rejection of a contribution, which may consist of any type, virtual or physical. The contribution may consist of information or opinion. Additionally, the contribution may consist of a suggestion for a decision to be approved or rejected. Governance is further comprised of calculating the value of a contribution by processing the perceived reliability or value by members, such a perceived value can be calculating, for example, by summing votes which may be individually weighted to each member. In addition, perceived value may be calculated by processing the contributions that link to a given contribution. Such linkage can occur, for example, by direct usage by members. Additionally, linkage could occur inherently when a user bases a further contribution on the original contribution or indirectly on other contributions so based. Governance is managed via a crowd-sourced mechanism such that the decisions are weighted by predictive analytics determined in part by feedback from internal users of the collaborative platform (eyePi).

A evaluation analytics submodule, 406, applies genetic algorithms and forecasting models stored in the project database library, 408, to select the approach or other factors related to the successful project. The evaluation analytics submodule, 406, may implement one or more forecasting techniques, including simple algorithms, including net present value, return on equity as well as statistical techniques such as Monte Carlo simulation (e.g., as applied in Oracle's Crystal Ball software), genetic evolution algorithms or machine learning to evaluate the optimal approach among many competing approaches. In some examples, the adoption of one approach over another by an increasing number of subject matter experts, corporate representatives, investors and entrepreneurs with the adoptions weighted by past successes in choosing a successful approach. In other examples, constraints imposed by the entrepreneur, corporate representatives or investors may determine the initial approach. In some examples, the predictive analytics incorporate the robust, optimizing forecasting techniques of Pinto et al. (U.S. Pat. No. 7,499,897, issued on Mar. 3, 2009; U.S. Pat. No. 7,562,058, issued on Jul. 14, 2009; U.S. Pat. No. 7,725,300, issued on May 25, 2010; U.S. Pat. No. 7,730,003, issued on Jun. 1, 2010; U.S. Pat. No. 7,933,762, issued on Apr. 26, 2011; U.S. Pat. No. 8,170,841 issued on May 1, 2012; U.S. Pat. No. 8,751,273 issued on Jun. 10, 2014 and U.S. patent application Ser. No. 10/826,949, filed Apr. 16, 2004, the contents of all of which are incorporated herein by reference), that manage historical data including historical data having missing values, which must be inferred.

A display module, 404, communicates the results of the analysis conducted by the evaluation analytics submodule, 406, to the entrepreneur 108, (FIG. 1).

In another example, the predictive analytics submodule, 406, may identify potential development paths based on an analysis of electronically-accessible sources of information, profile data stored in the database, 402, or both. For instance, potential pathways may be identified that meet one or more specified characteristics. In some examples, the evaluation analytics submodule, 406, may have access to databases to analyze characteristics of successful projects. In some examples, the evaluation analytics submodule, 406, may have access to a list of past or potential development approaches and may identify and rank potential pathways based on that list in terms of propensity to succeed based on historical data.

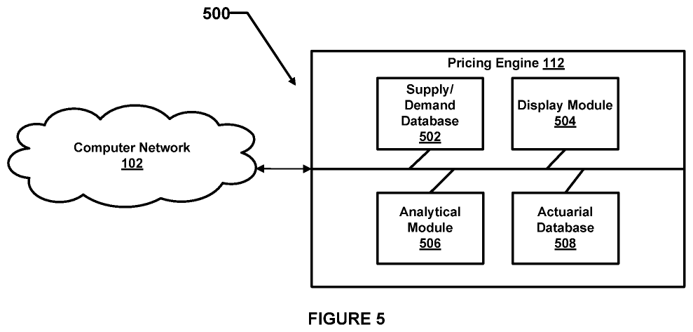

In the upcoming section reference is made to FIG. 5, a block diagram, 500, of an exemplary pricing engine, 112. The network environment, 100, further includes an analytics engine, 112, that is configured with services for facilitating payment by an entrepreneurial user, 108, by determining inferring milestone contributions by a subject matter user, 114. The milestone contributions of a subject matter user, 1148, may be displayed on a webpage belonging to an entrepreneurial user, 108. In some embodiments, the pricing engine may automatically assess the contribution value of a subject matter user, 1148, based on the terms of the development agreement. The pricing engine may alternately use competitive supply and demand information based on similar projects or on similar project completed by a subject matter user, 1148, found in project history databases to determine appropriate compensation. The pricing engine, 112, comprises a supply/demand database module, 502, a display module, 504, an analytical module, 506, and a database containing actuarial information based on subject matter expert profiles, and project information, 508.

The analytical module, 506, employing methods similar to that of the analytical module, 306, (FIG. 3), uses predictive analytics on the historical data of supply and demand in the supply/demand database module, 502, and on the historical data on subject matter experts and projects to assign appropriate compensation to the collaborative contributions of either subject matter experts or corporate consultants. For example, payments for services provided or solutions to problems or answers to questions or for feedback given, may be computed by predictive analytics using historical data of the contributor, such as MyPi Score, education of user, previous jobs or experiences of the user, previous answers of the user (fellow user reviews of these given answers), historical data of the remuneration, including estimates of the amount of real work needed to solve a problem or respond to a challenging question, the extent work is needed to complete the task, the amount of knowledge necessary to provide a logical and complete answer, the time needed to complete the work/service, the complexity of the service/feedback needed, the quality of the work/feedback/advice returned (based upon surveys/feedback from peers/other users), historical data of the value or products, projects, virtual companies based for instance on speculation (speculative idea of the future value of the project/product/virtual company), willingness of internal/external investors to invest in the project/product/virtual company, willingness of the internal eyePi users to invest/provide work/provide feedback/etc . . . , users' opinions of the validity/market viability of the project/product and the company/project management team, patentability of concepts, and ability of innovator to fund rounds of questions/feedback.

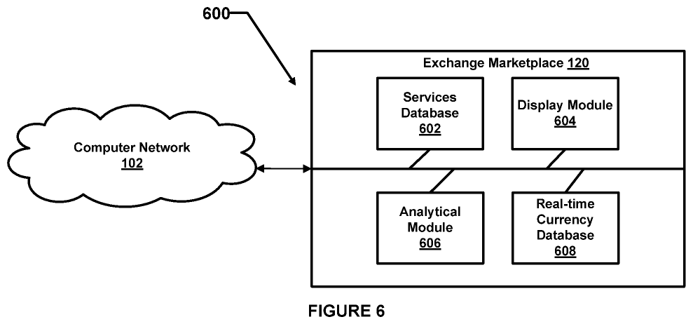

In the upcoming section reference is made to FIG. 6, a block diagram, 600, of an exemplary exchange marketplace, 120. The network environment, 100, further includes an exchange marketplace, 120, that is configured with services for facilitating exchange of services or assets, such as corporate shares, within the collaborative community for crypto currency or payment in standard currencies by exchanging CHIPS at current exchange rates. In some embodiments, the exchange marketplace engine may exchange the corporate shares earned by a subject matter user, 1148, based on the terms of the development agreement, for CHIPS provided by an investor or corporation. The exchange marketplace engine, 120, comprises a services database module, 602, a display module, 604, an analytical module, 606, and a database containing real-time information of current buying and selling rates for CHIPS versus standard international currencies such as USO or Euros, 608. The CHIPS could be exchanged for any item of value, including, but not limited to, corporate debt, convertible notes, stock indexes, futures, FOREX, stock options, and other real or virtual assets available via any market. The analytical module, 606, using methods similar to that of analytical module, 306, (FIG. 3), employs historical data from the services database module, 602, and the database of historical and real-time information on exchange rates to determine rational pricing using standard financial algorithms including the Black-Scholes Model for options.

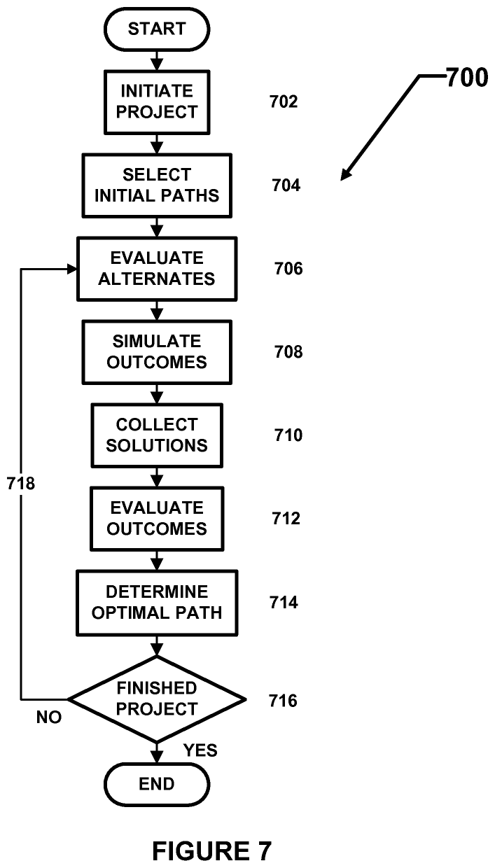

In the upcoming section reference is made to FIG. 7, an exemplary sequence, 700, of collaborative development facilitated by the present invention, an entrepreneurial registered user, 108, has formed a nascent company but needs to solve product, process, or delivery problems before the company can be viable and of interest to investors, 122. To solve the problem he needs to call on the global community of experts in the domain of the problem, 114, using the innovation engine. To do so he needs select and authenticate the appropriate experts, 114, negotiate what the contribution of an expert would be worth then pose the problem, collect and evaluate the solutions and distribute the appropriate compensation calling upon the pricing engine to calculate the quantity of CHIPS that the successful expert can using the exchange marketplace or corporate shares if the nascent company becomes attractive to investors or other companies or emerges as an independent company. Selection of contributors and negotiation of compensation can be performed by having the system use pre-selected criteria based in part on the profile of the users and the compensation can be determined based on the value of the work to the user posing the question.

Upon encountering a potentially solvable problem, the entrepreneur, 108, initiates a project, 702, on the network using the innovation engine, 110. Then with the team of contributors selected by predictive analytics, using the innovation engine, he selects the initial development paths, 704, crowd-sourced from his subject matter experts and other sources using the governance engine, 111. To the panel of selected contributors he poses the problem, answers questions, and provides relevant information. As project development along these alternate paths proceeds he evaluates the present alternate paths or others suggested by his subject matter experts and other sources, 706, using the governance engine, 111. As part of the evaluation process he simulates potential outcomes, 708, using Monte Carlo simulation or other analytic procedures using the governance engine, 111. As part of the evaluation process over a predefined discovery period collected from the selected contributors he collects from the development paths explored, the problem solutions or product prototypes, 710. At the conclusion of one iteration of development, he and his team evaluate the outcomes, 712, and select the optimal path, 714, using the governance engine, 111. Based on the evaluations using the governance engine and within the terms of the compensation contracts the selected contributors receive incentivization rewards in the form of the CHIPS currency that can be used for services within the collaborative community in the exchange marketplace or traded at current rates for standard currencies. At this choice point, 716, if the project has achieved its goal or the problem is solved or the question is answered the project finished. Otherwise, the next iteration of the project is undertaken, 718, with a review of alternates, 706, using the governance engine, 111.

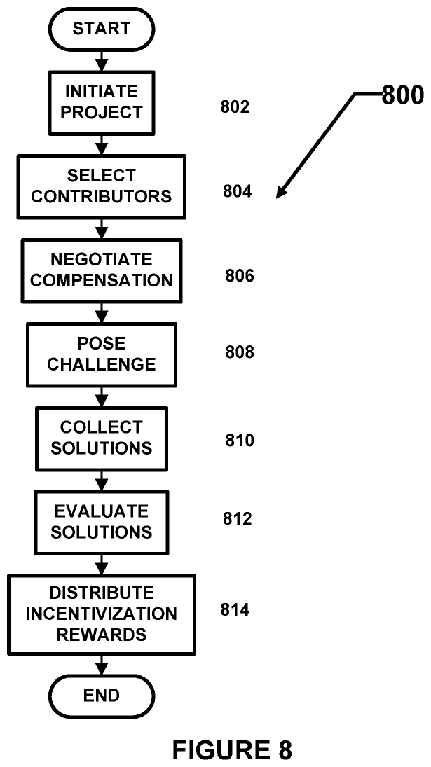

In the upcoming section reference is made to FIG. 8, an exemplary sequence, 800, of collaborative development facilitated by the present invention, an entrepreneurial registered user, 108, has formed a nascent company but he needs to solve product, process, or delivery problems before the company can be viable and of interest to investors, 122. To solve the problem he needs to call on the global community of experts in the domain of the problem, 114, using the innovation engine. To do so he needs to select and authenticate the appropriate experts, 114, negotiate what the contribution of an expert would be worth, and then pose the problem, collect and evaluate the solutions and distribute the appropriate compensation by calling upon the pricing engine to calculate the quantity of CHIPS that the successful expert deserves which can be used in the exchange marketplace or exchanged for corporate shares if the nascent company becomes attractive to investors or other companies or emerges as an independent company. Selection of contributors and negotiation of compensation can be performed by having the system use pre-selected criteria based in part on the profile of the users and the compensation can be determined based on the value of the work to the user posing the question.

Upon encountering a potentially solvable problem, the entrepreneur, 108, initiates a project, 802, on the network using the innovation engine, 110. Then he selects potential contributors to the solution of the problem or the system does this for the entrepreneur based on pre-selected criteria such as the profiles of the contributors and what each contributor has contributed in the past, 804, and he negotiates compensation contracts with the selected contributors, 806. To the panel of selected contributors he poses the problem, answers questions and provides relevant information, 808. Over a predefined discovery period potential solutions are collected from the selected contributors, 810, and evaluated, 812. Based on the evaluations and within the terms of the compensation contracts the selected contributors receive incentivization rewards in the form of the CHIPS currency, 814, that can be used for services within the collaborative community in the exchange marketplace or traded at current rates for standard currencies.

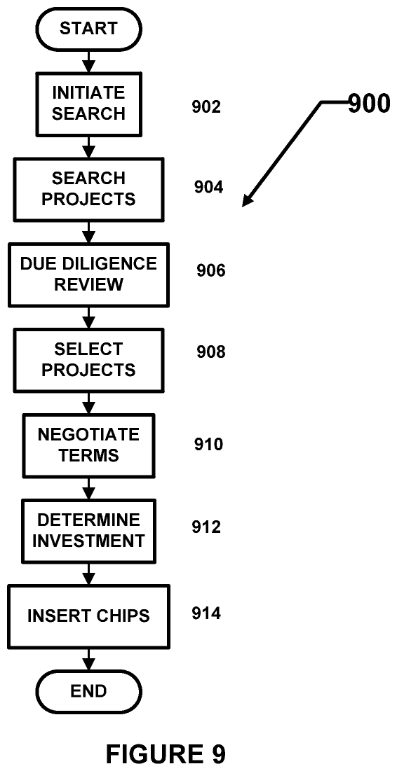

In the upcoming section reference is made to FIG. 9, an exemplary sequence, 900, of collaborative development facilitated by the present invention, an investor registered user, 122, has funds to invest in a nascent company but needs to determine the optimal vehicle for the investment so that the company can be not only viable but yields at maturity a high multiple of the investment. To do so he needs review the problems encountered, the quality of the solutions, the profiles of the entrepreneur, 108, and his team selected from 114, the current business plan and projected market, negotiate what the value of funds invested at this point in time, and then transfer the CHIPS to the appropriate account.

Upon determining there is an opportunity to add to his portfolio, the investor, 122, initiates a search, 902, then searches current projects, 904, to find a potential match. After extensive due diligence review, 906, including review of the profiles of the entrepreneur, 108, and his team or potential team, 114, the quality of the solutions to problems encountered, and the current business plan and the potential market, a project is selected, 908. After terms of an investment are negotiated, 910, an investment or tier of investments is scheduled, 912, by the investor or a group of investors, 122A . . . 122M, and the initial investment amount in CHIPS is made, 914.

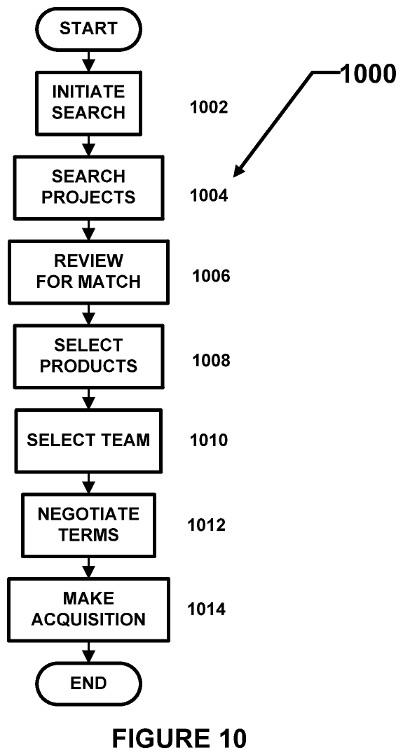

In the upcoming section reference is made to FIG. 10, an exemplary sequence, 1000, of collaborative development facilitated by the present invention: a corporate registered user, 124, needs to complement its existing product lines, augment current development, or acquire a full team to diversify and seeks the optimum solution outside its existing corporate environment. To do so the corporation needs access to leading edge developments in the relevant fields, the quality and potential of products in development, the profiles of the leaders, 108, and subject matter experts, 114, involved in the development, and the challenges encountered and overcome. If the corporate representative finds a match to corporate needs then negotiations are required to license, acquire, bring in-house the product development team or selected individuals as employees, or make an investment in the project for future products.

Upon determining there is a corporate need for new products, the corporate representative, 124, initiates a search, 1002, then searches current projects, 1004, to find a potential match. After extensive review, 1006, including review of the profiles of the entrepreneur, 108, and his team of experts, 114, and the quality and potential of products/solutions developed, a product is selected, 1008, along with a potential team of potential employees or consultants, 1010. Then the terms are negotiated for licensing of the product or process, bringing the product or product in-house, or investing in the project for the current or future products, 1012. Finally the financial component of the negotiated terms is completed with payment of the appropriate amount in CHIPS, 1014.

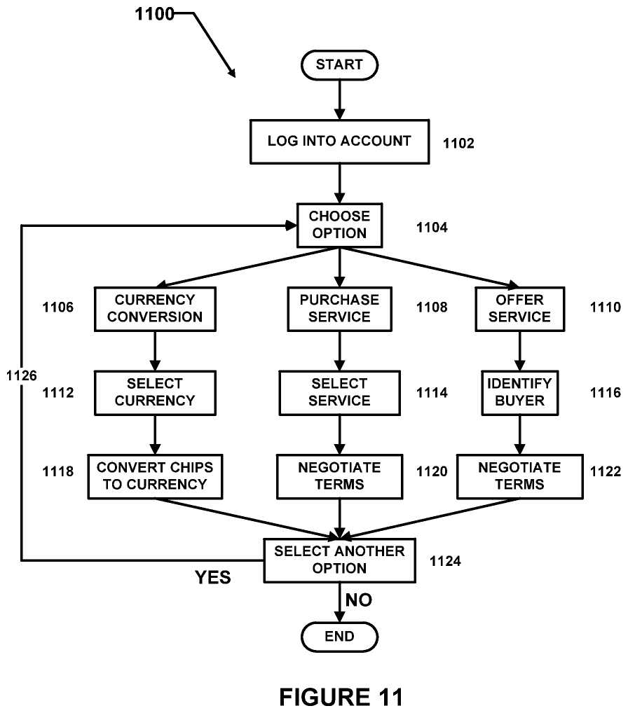

In the upcoming section reference is made to FIG. 11, an exemplary sequence, 1100, of collaborative development facilitated by the present invention, an exchange marketplace provides services to be traded or a means of converting the collaborative community currency (CHIPS) into standard currency at real-time conversion rates or a means for converting standard currencies into CHIPS. A registered user such as an entrepreneur, 108, or a subject matter expert, 114, or a representative of an investor, 122, or corporation, 124, need to purchase services or to offer services or to invest funds or to distribution compensation, or to withdraw funds. To meet these needs such persons require a secure arena, provided by the exchange marketplace engine, 120, in which such transactions can take place with the other parties to the potential transactions having been authenticated.

Upon requiring services from the exchange marketplace, a registered user, (108, 114,122,124), logs into to his account, 1102, then makes a choice of which type of transaction to engage in, 1104. If the registered user, for example, a subject matter expert, wishes to convert some earned CHIPS into US dollars or British pounds, he initiates a currency conversion, 1106, and selects the currency of choice, 1112, and views the exchange rate for CHIPs to standard currencies retrieved from the currency trading station, 608, on the display, 604, of the exchange marketplace engine, FIG. 6. After selecting a currency at the posted rate on the exchange the subject matter expert, 114, makes the conversion, 1118, and receives confirmation for example via email that the converted funds have been posted to an external account, for example, PayPal or a bank account. Conversely, a corporate representative, 124, or investor, 122, is able to convert standard currency into the currency of the collaborative community (CHIPS) using the exchange marketplace engine, FIG. 6. On the other hand, a user such as an entrepreneurial registered user, 108, needs the services of, for example, a professional expert such as a consultant or attorney on a fee-for-service basis. The user, 108, chooses to purchase services, 1108, then selects the appropriate service provider, 1114, and negotiates terms of compensation, 1120. On the other hand, a subject matter expert registered user, 114, who has logged into his account in the exchange, 1102, chooses a third option, 1104, to offer services, 1110. The subject matter expert registered user, 114, markets his services on the exchange engine display, 604, of the exchange marketplace engine, FIG. 6, and selects a prospective buyer of those services, 1116. The two registered users negotiate the terms of services and appropriate compensation, 1122, using the governance engine, FIG. 4. After completion of each of the options the register user can make a choice, 1124, to continue in the exchange marketplace, 1126, for another service, 1104, or to exit the exchange marketplace and return to another arena of the collaborative development community.

This written description uses examples to disclose the invention, including the best mode, and also to enable any person skilled in the art to practice the invention, including making and using any devices or systems and performing any incorporated methods. The patentable scope of the invention is defined in the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

While the invention has been described by reference to certain preferred embodiments, it should be understood that these embodiments are within the spirit and scope of the inventive concepts described. Accordingly, it is intended that the invention not be limited by the embodiments, but that it have the full scope permitted by the language of the following claims.

We claim:

1. A collaborative enterprise development system comprising:
(a) a secure communication network configured to connect authenticated users;
(b) an innovation engine configured to select authenticated subject matter experts;
(c) a governance engine configured to optimize the project development path;
(d) a pricing engine configured to evaluate remuneration of solutions contributed by said subject matter experts;
(e) an exchange engine that trades crypto currency for services and items of value;
wherein said authenticated user inputs initial problems, poses research problems or questions, inputs instructions in order to receive one or more solutions to enterprise development projects.

2. The secure communication network in the collaborative development system of claim 1, further comprising a network that connects authenticated persons willing to pay for crowd-sourced solutions to technical problems and authenticated subject matter experts willing to sell solutions to said problems in return for any type of currency, including crypto currency or equity interests,

3. The secure communication network in the collaborative development system of claim 1, further comprising a network of mobile user devices for communicating over the computer network in which the said user can input initial projects, pose research problems or questions, input instructions, and receive solutions for enterprise development willing to pay for crowd-sourced solutions provided by selected authenticated subject matter experts willing to provide solutions in return for remuneration.

4. The innovation engine of the collaborative development system of claim 1, further comprising an engine that selects of authenticated subject matter experts by predictive analytics based on historical data.

5. The governance engine of the collaborative enterprise development system of claim 1, further comprising an engine:
a) that selects initial developmental paths based in part on input from authenticated, peer-reviewed subject matter experts;
b) that evaluates alternate developmental paths based in part on mathematical simulation of outcomes;
c) that assesses solutions provided by said authenticated, peer-reviewed, subject matter experts;
d) that computes using predictive analytics the propensity of success of alternate developmental paths based at least in part on historical data;
e) that selects the development path maximizing the propensity of success, minimizing resources and time to completion using predictive analytics based on historical data.

6. The pricing engine of the collaborative enterprise development system of claim 1, further comprising an engine that computes remuneration of problem solutions with predictive analytics based in part on historical data.

7. The exchange engine of the collaborative enterprise development system of claim 1 further comprising an engine that invests the crypto currency earned by users of the system in securities, comprising corporate debt, convertible notes, stock indexes, futures, FOREX, stock options, stocks, and other real or virtual assets available via any market.

8. The collaborative enterprise development system of claim 1 further comprising non-transitory computer readable medium comprising:
program code to interactively communicate information among entrepreneurs, subject matter experts, investors and corporate representatives.

9. A computer-based method for collaborative enterprise development, the computer-based method comprising:
(a) communicating securely among two or more authenticated users f chosen from a group of entrepreneurs, subject matter experts, investors or corporate representatives;
(b) selecting authenticated subject matter experts that solve problems with innovative solutions;
(c) governing development project path selection from alternates using predictive analytics based on historical data;
(d) pricing remuneration for said authenticated subject matter experts based on evaluation of said innovative solutions;
(e) trading crypto currency for at least one of services and items of value;
wherein said authenticated user inputs initial problems, poses research problems or questions, inputs instructions in order to receive one or more solutions to enterprise development projects and said authenticated subject matter expert receive remuneration.

10. The computer-based method of communicating securely of the computer-based method of collaborative development of claim 9 further comprising:
connecting authenticated persons willing to pay for crowd-sourced solutions to technical problems and authenticated subject matter experts willing to sell solutions to said problems in return for any type of currency, including crypto currency or equity interests.

11. The computer-based method of communicating securely of the computer-based method of collaborative development of claim 9 further comprising:
communicating over a computer network of mobile user devices in which the said user can input initial projects, pose research problems or questions, input instructions, and receive solutions for enterprise development willing to pay for crowd-sourced solutions provided by selected authenticated subject matter experts willing to provide solutions in return for remuneration.

12. The computer-based selecting authenticated subject matter experts method of the computer-based method of collaborative development of claim 9 further comprising:
selecting of authenticated subject matter experts by predictive analytics based on historical data.

13. The computer-based governing development method of the computer-based method of collaborative method of claim 9 further comprising:
a) selecting initial developmental paths based in part on input from authenticated, peer-reviewed subject matter experts;
b) evaluating alternate developmental paths based in part on mathematical simulation of outcomes;
c) assessing solutions provided by said authenticated, peer-reviewed, subject matter experts;
d) computing using predictive analytics the propensity of success of alternate developmental paths based at least in part on historical data;
e) selecting the development path maximizing the propensity of success, minimizing resources and time to completion using predictive analytics based on historical data.

14. The computer-based pricing remuneration method the computer-based collaborative enterprise development method claim 9, further comprising:
computing remuneration of problem solutions with predictive analytics based in part on historical data.

15. The computer-based exchange trading method of the computer-based the collaborative enterprise development method of claim 9 further comprising:
Investing the crypto currency earned by authenticated subject matter experts in securities, comprising corporate debt, convertible notes, stock indexes, futures, FOREX, stock options, stocks, and other real or virtual assets available via any market.

16. A computer-based method of governing collaborative enterprise product development, the method comprising:
selecting initial developmental paths based in part on input from authenticated, peer-reviewed subject matter experts.

17. The computer-based method of governing collaborative enterprise product development of claim 16 further comprising:
evaluating alternate developmental paths based in part on mathematical simulation of outcomes.

18. The computer-based method of governing collaborative enterprise product development of claim 16 further comprising:
assessing solutions provided by said authenticated, peer-reviewed, subject matter experts.

19. The computer-based method of governing collaborative enterprise product development of claim 16 further comprising:
computing using predictive analytics the propensity of success of alternate developmental paths based at least in part on historical data.

20. The computer-based method of governing collaborative enterprise product development of claim 16 further comprising:
selecting the development path maximizing the propensity of success, minimizing resources and minimizing time to completion using predictive analytics based on historical data.
